(19) United States
(12) Patent Application Publication
(10) Pub. No.: US 2016/0005108 A1
(43) Pub. Date: Jan. 7, 2016

(54) Fraud-Resistant Electronic Processing of a Rent-to-Own Lease Transaction

(71) Applicant: Go-Lease, LLC, Loveland, OH (US)

(72) Inventor: Mark A. Willis, Loveland, OH (US)

(21) Appl. No.: 14/323,202

(22) Filed: Jul. 3, 2014

(51) Int. Cl. G06Q 30/06; G06Q 20/34; G06Q 20/32

(52) U.S. Cl. CPC G06Q 30/0645; G06Q 20/3274; G06Q 20/351

(57) ABSTRACT

A system, method, apparatus, and computer program product for fraud-resistant electronic processing of a rent-to-own lease transaction are disclosed. A method may include receiving a lease application including customer information and an indication of an item to be purchased in a brick and mortar store. The method may further include determining, based on the customer information and the indication of the item, a lease amount for which the customer is eligible. The method may additionally include providing a lease offer generated based on the lease amount to a mobile communication device associated with the customer. The method may also include receiving an electronic acceptance of the lease offer. The method may further include generating a virtual payment card for at least a portion of the lease amount that is usable for purchase of the item in the store and providing the virtual payment card to the mobile communication device.

### FIELD OF THE DISCLOSURE

Aspects of the disclosure relate to rent-to-own leasing and, more particularly, to fraud-resistant electronic processing of a rent-to-own lease transaction.

### BACKGROUND

Rent-to-own lease transactions are frequently used by customers with insufficient funds to pay for items and who do not qualify for traditional credit financing. Rent-to-own lease transactions are used by customers to lease a wide variety of items, including furniture, appliances, electronics, tires, musical instruments, and jewelry. If a customer leasing an item on a rent-to-own basis fulfills all lease payment obligations, the customer will own the item outright at the end of the lease term. However, if the customer fails to fulfill the lease payment obligations, the lessor can repossess the item from the customer.

Lessors providing rent-to-own leases perform an underwriting process in order to verify the identity of a customer and determine that the customer has the financial ability to meet the lease obligations. The burden of underwriting a lease agreement for a rent-to-own lease transaction deters many vendors from providing rent-to-own financing options, thereby limiting the number of vendors from which a customer can lease an item on a rent-to-own basis. Further, the lack of a satisfactory way to perform underwriting and prevent fraudulent transactions has been a barrier to third-party lessors providing rent-to-own services usable for transactions at any retailer.

### SUMMARY

Systems, methods, apparatuses, and computer program products for fraud-resistant electronic processing of rent-to-own lease transactions are disclosed. Embodiments disclosed herein can automate aspects of rent-to-own lease transaction processing while providing safeguards protecting against fraudulent transactions. These embodiments can ease the burden on customers and store personnel for completing a rent-to-own lease transaction, while enabling customers otherwise unable to purchase an item to lease the item on a rent-to-own basis, thereby increasing retailer revenues. Some such embodiments enable a customer to lease an item on a rent-to-own basis even from stores that do not have in-house rent-to-own programs. Additionally, some such example embodiments enable a customer to lease an item on a rent-to-own basis that is offered by an online retailer.

A method for electronically processing a rent-to-own lease transaction for an in-store purchase may include receiving a lease application including customer information and an indication of an item to be purchased in a brick and mortar store (e.g., a brick and mortar retail store). The lease application may be submitted by a customer for the rent-to-own lease transaction. The method may further include determining, based at least in part on the customer information and the indication of the item, a lease amount for which the customer is eligible. The method may additionally include providing a lease offer generated based at least in part on the lease amount to a mobile communication device associated with the customer. The method may also include receiving an electronic acceptance of the lease offer. The method may further include generating a virtual payment card for at least a portion of the lease amount that is usable for purchase of the item in the brick and mortar store. The method may additionally include providing the virtual payment card to the mobile communication device.

A system for processing a rent-to-own lease transaction for an in-store purchase may include at least one processor and at least one memory storing computer program instructions. When the computer program instructions are executed by the at least one processor, the computer program instructions may cause the system to perform the above-described method for electronically processing a rent-to-own lease transaction for an in-store purchase.

A computer program product for processing a rent-to-own lease transaction for an in-store purchase may include at least one non-transitory computer readable storage medium having computer program instructions stored thereon. The computer program instructions may include program instructions, which when executed by one or more processors, cause the processor to perform the above-described method for electronically processing a rent-to-own lease transaction for an in-store purchase.

A method for electronically processing a rent-to-own lease transaction for an online purchase may include receiving a lease application including customer information and an indication of an item to be purchased from an online retailer. The lease application may be submitted by a customer for the rent-to-own lease transaction. The method may further include determining, based at least in part on the customer information and the indication of the item, a lease amount for which the customer is eligible. The method may also include receiving a uniform resource locator (URL) for a web page via which the item is purchasable from the online retailer. The method may additionally include providing a lease offer generated based at least in part on the lease amount to a computing device associated with the customer. The method may also include receiving an electronic acceptance of the lease offer. The method may further include using the URL to purchase the item for the customer from the online retailer.

A system for processing a rent-to-own lease transaction for an online purchase may include at least one processor and at least one memory storing computer program instructions. When the computer program instructions are executed by the at least one processor, the computer program instructions may cause the system to perform the above-described method for electronically processing a rent-to-own lease transaction for an online purchase.

A computer program product for processing a rent-to-own lease transaction for an online purchase may include at least one non-transitory computer readable storage medium having computer program instructions stored thereon. The computer program instructions may include program instructions, which when executed by one or more processors, cause the processor to perform the above-described method for electronically processing a rent-to-own lease transaction for an online purchase.

It will be appreciated that the above Summary is provided merely for purposes of summarizing some example embodiments so as to provide a basic understanding of some aspects of the disclosure. As such, it will be appreciated that the above described example embodiments are merely examples of some embodiments and should not be construed to narrow the scope or spirit of the disclosure in any way. It will be appreciated that the scope of the disclosure encompasses many potential embodiments, some of which will be further described below, in addition to those here summarized. Further, other aspects and advantages of embodiments disclosed herein will become apparent from the following detailed description taken in conjunction with the accompanying drawings which illustrate, by way of example, the principles of the described embodiments.

### BRIEF DESCRIPTION OF THE DRAWINGS

Having thus described the disclosure in general terms, reference will now be made to the accompanying drawings, which are not necessarily drawn to scale, and wherein:

FIG. 1 illustrates a system for electronically processing a rent-to-own lease transaction in accordance with some example embodiments;

FIG. 2 illustrates a block diagram of an apparatus that may be implemented on a rent-to-own service provider system in accordance with some example embodiments;

FIG. 3 illustrates a block diagram of an apparatus that may be implemented on a user device in accordance with some example embodiments;

FIGS. 4A-4G illustrate an example user interface that may be provided by some example embodiments to enable a customer to submit a lease application;

FIG. 5 illustrates a flowchart according to an example method for electronically processing a rent-to-own lease transaction for an in-store purchase in accordance with some example embodiments;

FIGS. 6A-6D illustrate an example user interface that may be provided by some example embodiments to enable a customer to complete a rent-to-own lease transaction for an in-store purchase accordance with some example embodiments; and

FIG. 7 illustrates a flowchart according to an example method for electronically processing a rent-to-own lease transaction for an online purchase in accordance with some example embodiments.

### DETAILED DESCRIPTION

The present disclosure now will be described more fully hereinafter with reference to the accompanying drawings, in which some, but not all aspects of the disclosure are shown. Indeed, the disclosure may be embodied in many different forms and should not be construed as limited to the aspects set forth herein; rather, these aspects are provided so that this disclosure will satisfy applicable legal requirements. Like numbers refer to like elements throughout.

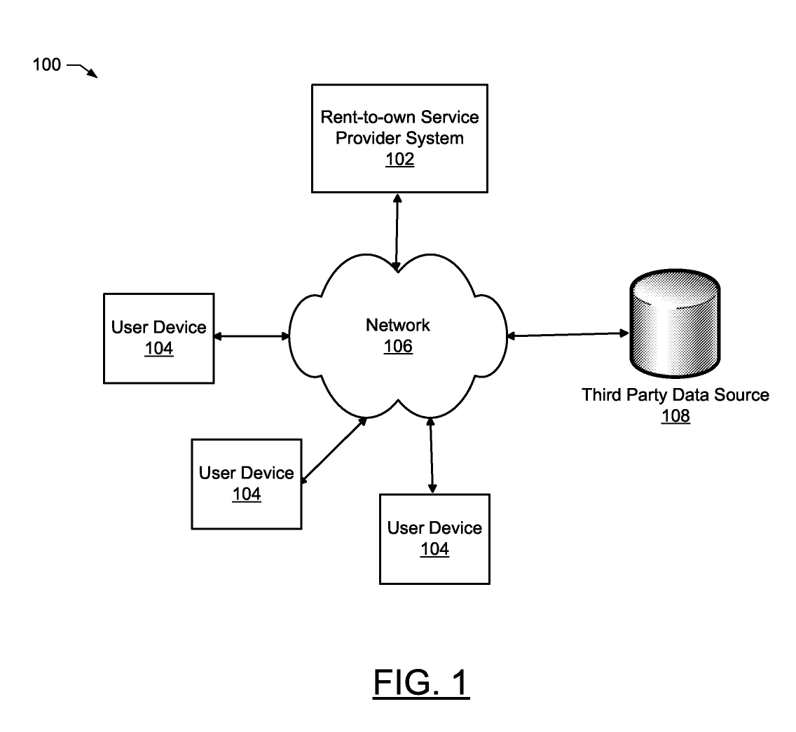

FIG. 1 illustrates a system 100 for electronically processing a rent-to-own lease transaction in accordance with some example embodiments. The system 100 may include a rent-to-own service provider system 102 (hereinafter, “the service provider system 102”) and one or more user devices 104, with three such user devices 104 are illustrated in FIG. 1 by way of example, that may be configured to communicate over a network 106.

The network 106 may be embodied as any network, or combination of networks, which may enable two or more computing devices to communicate with each other. For example, the network 106 may comprise one or more wireline networks, one or more wireless networks (e.g., a cellular network, wireless local area network, wireless metropolitan area network, wireless wide area network, some combination thereof, or the like), or a combination thereof, and in some example embodiments may comprise the Internet.

The service provider system 102 may be operated by a rent-to-own service provider that may offer leases for items to qualified customers on a rent-to-own basis. The service provider system 102 may be embodied as a computer system accessible by the network 106, which may comprise one or more computing devices that may be configured to receive a lease application submitted via a user device 104 and process a rent-to-own lease transaction in accordance with various example embodiments disclosed herein. The service provider system 102 may be embodied as one or more servers, a cloud computing infrastructure, some combination thereof or the like. In some example embodiments in which the service provider system 102 comprises a plurality of computing devices, the respective devices that comprise the service provider system 102 of such embodiments may be in communication with each other via a network, such as the network 106.

A user device 104 may comprise any computing device that may be used by a customer to complete and submit a lease application in accordance with various embodiments. For example, in some embodiments, a user device 104 may be embodied as a mobile communication device, such as a smart phone device, tablet computing device, personal digital assistant (PDA), digital media device, some combination thereof or the like, that may be associated with a customer. In some embodiments in which a user device 104 is embodied as a mobile communication device, the mobile communication device may belong to the customer. In some embodiments in which a user device 104 is embodied as a mobile communication device, the mobile communication device may be made available for customer use by a store to enable customers to complete lease applications for rent-to-own lease transactions for in-store purchases. As a further example, in some embodiments, a user device 104 may be embodied as a personal computer, such as a desktop computer, laptop computer, or the like.

The user device 104 may be configured to display a graphical user interface enabling a user to complete a lease application. In some example embodiments, the graphical user interface may be accessed by the user device 104 from the service provider system 102 via the network 106. For example, the service provider system 102 may be configured to provide access to a portal or other interface, such as a web-based interface, that may be accessed via a thin client and/or other client application that may be installed on the user device 104. As a more particular example, in some embodiments, the service provider system 102 may provide one or more web pages that may be accessed by a browser application that may be installed on the user device 104. As another example, in some embodiments, the user device 104 may have a dedicated application (e.g., a mobile app in some embodiments in which the user device 104 is embodied as a mobile computing device) that may be configured to enable a user to complete a lease application and submit the lease application to the service provider system 102.

In some example embodiments, the system 100 may further include one or more third party data sources 108. A third party data source 108 may comprise a database that may be accessed by the service provider system 102 over the network 106. The third party data source 108 may maintain information that may be used by service provider system 102 to verify consumer identity information provided by a customer in a lease application and/or to access additional information about a customer's finances, asset data, historical residence addresses, phone numbers, email addresses, and/or other information that may be used for underwriting a lease application. In this regard, information that may be obtained from a third party data source may be used to identify fraudulent and/or potentially fraudulent lease applications. By way of non-limiting example, a third party data source 108 may include a database that may be provided by state governments, LEXIS NEXIS™, NEUSTAR™, TARGUS™, and/or other source of consumer identity, residence data, asset data, biographic and/or financial information about individuals that may be used for lease underwriting.

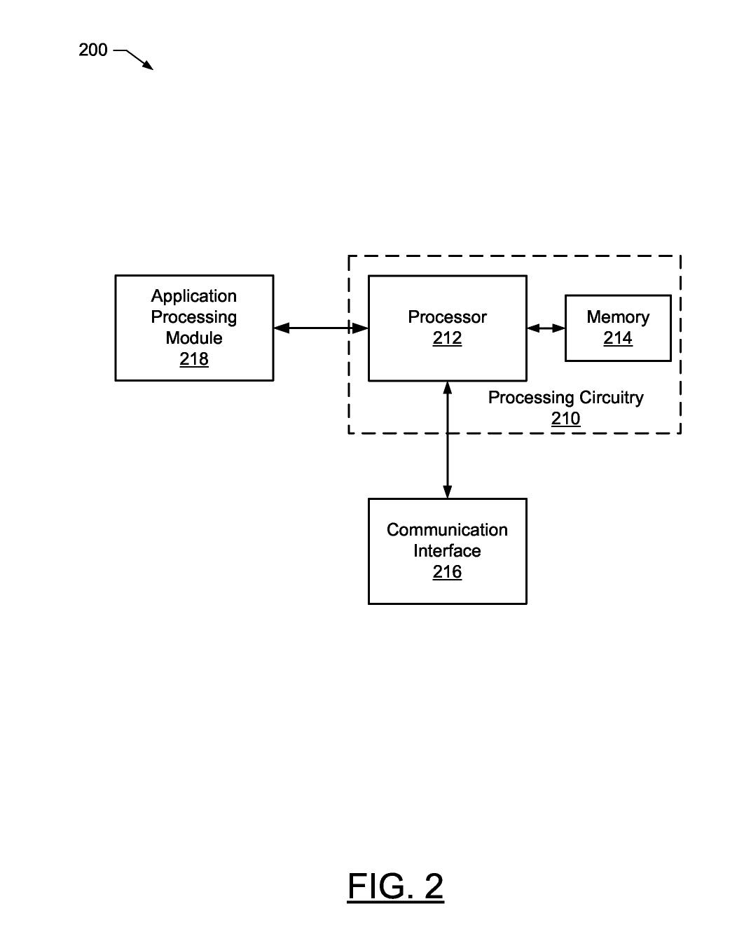

FIG. 2 illustrates a block diagram of an apparatus 200 that may be implemented on the service provider system 102 in accordance with some example embodiments. As such, it will be appreciated that elements of the apparatus 200 may be implemented on a single computing device, or, in some embodiments, may be distributed across a plurality of computing devices collectively providing functionality of the service provider system 102 in accordance with one or more example embodiments. In some embodiments in which elements of the apparatus 200 are distributed across a plurality of computing devices, the elements may be in operative communication with each other via a network, such as the network 106.

It will be appreciated that the components, devices or elements illustrated in and described with respect to FIG. 2 below may not be mandatory and thus some may be omitted in certain embodiments. Additionally, some embodiments may include further or different components, devices or elements beyond those illustrated in and described with respect to FIG. 2.

In some example embodiments, the apparatus 200 may include processing circuitry 210 that is configurable to perform functions in accordance with one or more example embodiments disclosed herein. In this regard, the processing circuitry 210 may be configured to perform and/or control performance of one or more functionalities of the service provider system 102 in accordance with various example embodiments. Thus, the processing circuitry 210 may be configured to perform data processing, application execution and/or other processing and management services according to one or more example embodiments.

In some example embodiments, the processing circuitry 210 may include a processor 212 and, in some embodiments, such as that illustrated in FIG. 2, may further include a memory 214. The processing circuitry 210 may be in communication with or otherwise control a communication interface 216 and/or application processing module 218.

The processor 212 may be embodied in a variety of forms. For example, the processor 212 may be embodied as various hardware processing means, such as a microprocessor, a coprocessor, a controller or various other computing or processing devices including integrated circuits such as, for example, an ASIC (application specific integrated circuit), an FPGA (field programmable gate array), some combination thereof, or the like. Although illustrated as a single processor, it will be appreciated that the processor 212 may comprise a plurality of processors. The plurality of processors may be in operative communication with each other and may be collectively configured to perform one or more functionalities of the service provider system 102. In some embodiments in which the service provider system 102 is embodied as a plurality of computing devices, a plurality of processors, which may collectively form the processor 212, may be distributed across a plurality of computing devices that may be in operative communication with each other directly and/or via a network, such as the network 106. In some example embodiments, the processor 212 may be configured to execute instructions that may be stored in the memory 214 and/or that may be otherwise accessible to the processor 212. As such, whether configured by hardware or by a combination of hardware and software, the processor 212 may be capable of performing operations according to various embodiments while configured accordingly.

In some example embodiments, the memory 214 may include one or more memory devices. Memory 214 may include fixed and/or removable memory devices. In embodiments in which the memory 214 includes a plurality of memory devices, the plurality of memory devices may be embodied on a single computing device, or may be distributed across a plurality of computing devices, which may collectively provide functionality of the service provider system 102. In some embodiments, the memory 214 may provide a non-transitory computer-readable storage medium that may store computer program instructions that may be executed by the processor 212. In this regard, the memory 214 may be configured to store information, data, applications, instructions and/or the like for enabling the service provider system 102 to carry out various functions in accordance with one or more example embodiments. In some embodiments, the memory 214 may be in communication with one or more of the processor 212, communication interface 216, or application processing module 218 via one or more buses for passing information among components of the apparatus 200.

The apparatus 200 may further include a communication interface 216. The communication interface 216 may enable the service provider system 102 to communicate with one or more further computing devices, such as over a network (e.g., network 106). In this regard, the communication interface 216 may include one or more interface mechanisms for enabling communication with other devices and/or networks. As such, the communication interface 216 may include, for example, an antenna (or multiple antennas) and supporting hardware and/or software for enabling communications with a wireless communication network (e.g., a cellular network, Wi-Fi, WLAN, and/or the like) and/or a communication modem or other hardware/software for supporting communication via cable, digital subscriber line (DSL), USB, FireWire, Ethernet, one or more optical transmission technologies, and/or other wireline networking methods. Thus, for example, the communication interface 216 may be configured to enable communication between the service provider system 102 and one or more of a user device 104 and third party data source 108 over the network 106.

The apparatus 200 may further include the application processing module 218. The application processing module 218 may be embodied as various means, such as circuitry, hardware, a computer program product comprising a computer readable medium (for example, the memory 214) storing computer readable program instructions executable by a processing device (for example, the processor 212), or some combination thereof. In some embodiments, the processor 212 (or the processing circuitry 210) may include, or otherwise control the application processing module 218. The application processing module 218 may be configured to receive a lease application submitted by a customer using a user device 104, and may be configured to process a rent-to-own lease transaction in accordance with various example embodiments disclosed herein.

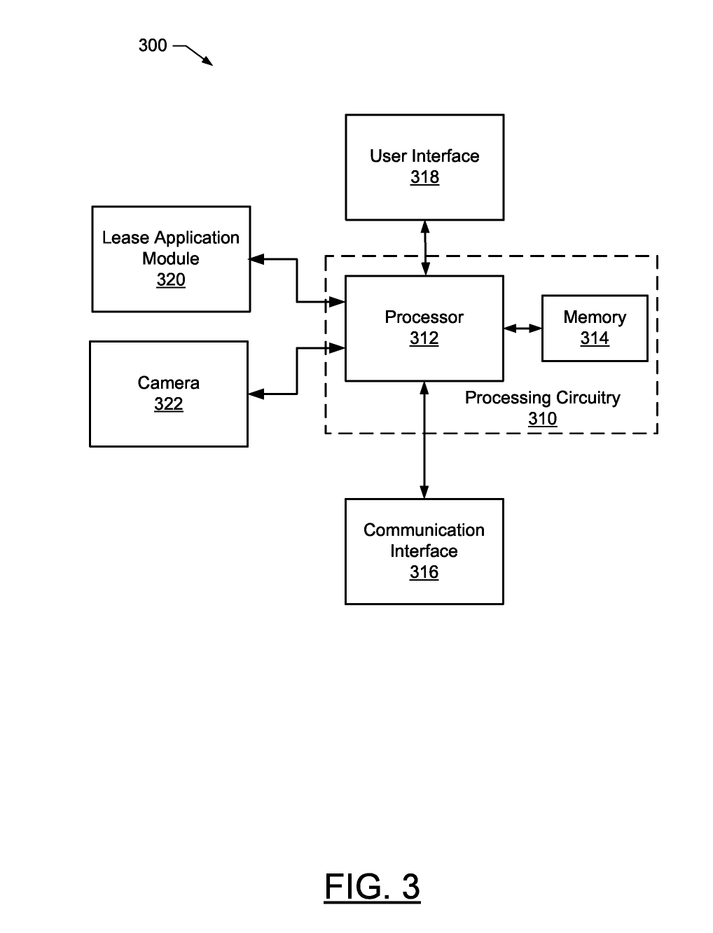

FIG. 3 illustrates a block diagram of an apparatus 300 that may be implemented on a user device 104 in accordance with some example embodiments. It will be appreciated that the components, devices or elements illustrated in and described with respect to FIG. 3 below may not be mandatory and thus some may be omitted in certain embodiments. Additionally, some embodiments may include further or different components, devices or elements beyond those illustrated in and described with respect to FIG. 3.

In some example embodiments, the apparatus 300 may include processing circuitry 310 that is configurable to perform functions in accordance with one or more example embodiments disclosed herein. In this regard, the processing circuitry 310 may be configured to perform and/or control performance of one or more functionalities of a user device 104 in accordance with various example embodiments. Thus, the processing circuitry 310 may be configured to perform data processing, application execution and/or other processing and management services according to one or more example embodiments.

In some example embodiments, the processing circuitry 310 may include a processor 312 and, in some embodiments, such as that illustrated in FIG. 3, may further include memory 314. The processing circuitry 310 may be in communication with or otherwise control a communication interface 316, user interface 318, lease application module 320, and/or a camera 322.

The processor 312 may be embodied in a variety of forms. For example, the processor 312 may be embodied as various hardware processing means, such as a microprocessor, a coprocessor, a controller or various other computing or processing devices including integrated circuits such as, for example, an ASIC (application specific integrated circuit), an FPGA (field programmable gate array), some combination thereof, or the like. Although illustrated as a single processor, it will be appreciated that the processor 312 may comprise a plurality of processors. The plurality of processors may be in operative communication with each other and may be collectively configured to perform one or more functionalities of a user device 104. In some example embodiments, the processor 312 may be configured to execute instructions that may be stored in the memory 314 and/or that may be otherwise accessible to the processor 312. As such, whether configured by hardware or by a combination of hardware and software, the processor 312 may be capable of performing operations according to various embodiments while being configured accordingly.

In some example embodiments, the memory 314 may include one or more memory devices. Memory 314 may include fixed and/or removable memory devices. In some embodiments, the memory 314 may provide a non-transitory computer-readable storage medium that may store computer program instructions that may be executed by the processor 312. In this regard, the memory 314 may be configured to store information, data, applications, instructions and/or the like for enabling a user device 104 to carry out various functions in accordance with one or more example embodiments. In some embodiments, the memory 314 may be in communication with one or more of the processor 312, communication interface 316, user interface 318, lease application module 320, and camera 322 via one or more buses for passing information among components of the apparatus 300.

The apparatus 300 may further include a communication interface 316. The communication interface 316 may be configured to enable a user device 104 to communicate with one or more further computing devices, such as over a network (e.g., network 106). In this regard, the communication interface 316 may include one or more interface mechanisms for enabling communication with other devices and/or networks. As such, the communication interface 316 may include, for example, an antenna (or multiple antennas) and supporting hardware and/or software for enabling communications with a wireless communication network (e.g., a cellular network, Wi-Fi, WLAN, and/or the like) and/or a communication modem or other hardware/software for supporting communication via cable, digital subscriber line (DSL), USB, FireWire, Ethernet, one or more optical transmission technologies, and/or other wireline networking methods. Thus, for example, the communication interface 316 may be configured to enable communication between a user device 104 and the service provider apparatus 102 over the network 106.

In some example embodiments, the apparatus 300 may include the user interface 318. The user interface 318 may be in communication with the processing circuitry 310 to receive an indication of a user input and/or to provide an audible, visual, mechanical, or other output to a user. As such, the user interface 318 may include, for example, a keyboard, a mouse, a joystick, a display, a touch screen display, a microphone, a speaker, one or more biometric input devices (e.g., a visual or sensorial tracing device that may track body part or eye movements), and/or other input/output mechanisms. In embodiments wherein the user interface 318 comprises a touch screen display, the user interface 318 may additionally be configured to detect and/or receive an indication of a touch and/or other movement gesture or other input to the display. The user interface 318 of some example embodiments may be used by a customer to complete a lease application. In this regard, a graphical user interface enabling a customer to enter information for a lease application and to complete a rent-to-own lease transaction may be displayed on a display of the user interface 318 of some example embodiments. An input element(s) of the user interface 318 may be used by a customer to enter information for a lease application and accept a lease offer that may be provided by the service provider system 102.

The apparatus 300 may further include lease application module 320. The lease application module 320 may be embodied as various means, such as circuitry, hardware, a computer program product comprising a computer readable medium (for example, the memory 314) storing computer readable program instructions executable by a processing device (for example, the processor 312), or some combination thereof. In some embodiments, the processor 312 (or the processing circuitry 310) may include, or otherwise control, the lease application module 320.

The lease application module 320 of some example embodiments may be configured to control display of a lease application and interact with the service provider system 102 to support processing of a rent-to-own lease transaction on the basis of a lease application submitted by a customer using a user device 104. For example, in some embodiments, the lease application module 320 may be configured to control a thin client and/or other application, which may be used to access and interact with a web interface that may be provided by the service provider system 102 of some example embodiments. In this regard, the lease application module 320 may be configured to present a graphical user interface for enabling completion and submission of a lease application to a customer (e.g., on a display of the user interface 318) based at least in part on instructions (e.g., in the form of web page code and/or the like) that may be received from the service provider apparatus 102 of some example embodiments. Additionally or alternatively, in some example embodiments, functionality of the lease application module 320 may be provided by an application (e.g., a mobile app) that may be downloaded and installed on a user device 104 and executed by the processor 312.

In some example embodiments, the apparatus 300 may further include a camera 322. However, in some embodiments, the camera 322 may be omitted. A camera 322 may, for example, be included in embodiments in which the apparatus 300 is implemented on a user device 104 that is embodied as a mobile communication device. The camera 322 may be configured to capture digital images that may be submitted attendant to completion of a lease application. For example, the camera 322 may be used to capture an image of a customer's person (e.g., a portrait and/or other image that may include the customer's face, such as for facial recognition/validation purposes), driver license, paycheck stub, and/or other information that may be submitted in a lease application. As a further example, the camera 322 may be used to capture an image of a receipt for an in-store purchase that may be submitted to and maintained by the service provider system 102 in a record for a rent-to-own lease transaction.

Having now described aspects of the system for electronically processing a rent-to-own lease transaction in accordance with various embodiments, electronic processing of a rent-to-own lease transaction in accordance with some example embodiments will now be described. A customer wishing to lease an item on a rent-to-own basis may use the user device 104 to access and complete a lease application by the user device. In this regard, the lease application module 320 may be configured to control display of a graphical user interface via which a user may complete a lease application and perform other interactions for completing a rent-to-own lease transaction. In some example embodiments, the customer may create an account with the rent-to-own service provider operating the service provider system 102. The customer may accordingly log onto his or her account to complete and submit a lease application.

In accordance with some example embodiments, the lease application may be fully completed contemporaneously with the time of item purchase. For example, in some embodiments, a lease application may be fully completed inside a brick and mortar store in which a customer is making a rent-to-own lease transaction. As another example, in some embodiments, a customer may complete a lease application contemporaneously with making an online purchase.

Additionally or alternatively, in some example embodiments, a customer may at least partially complete a lease application prior to purchase and the completed portion of the lease application may be maintained by the service provider system 102 to enable later purchase of the item. The service provider system 102 may perform at least a portion of the processing of the lease application and underwriting the lease based on the partially completed lease application, and may pre-approve the customer for up to a maximum lease amount based on a category of item that the customer wishes to lease. The customer may then shop and complete the rent-to-own lease transaction when the customer has identified the particular item to be purchased.

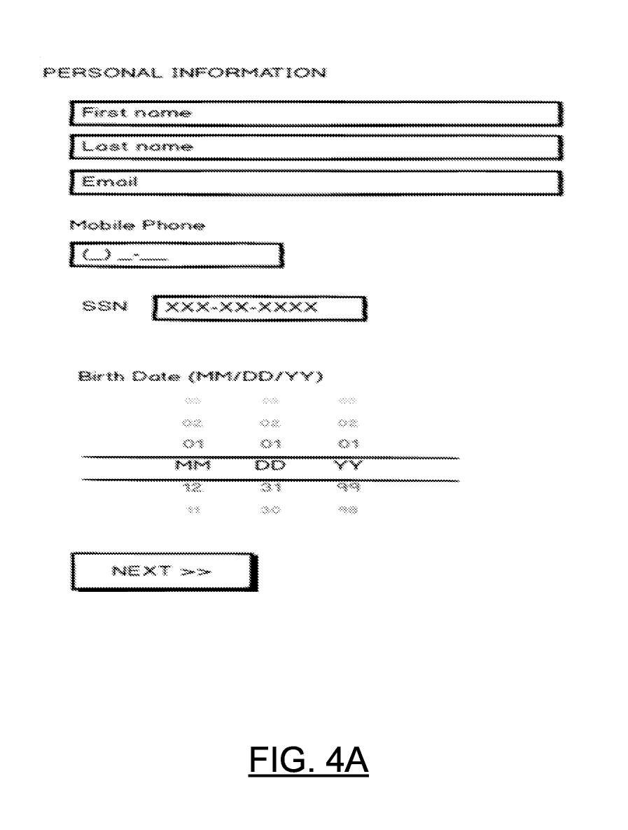

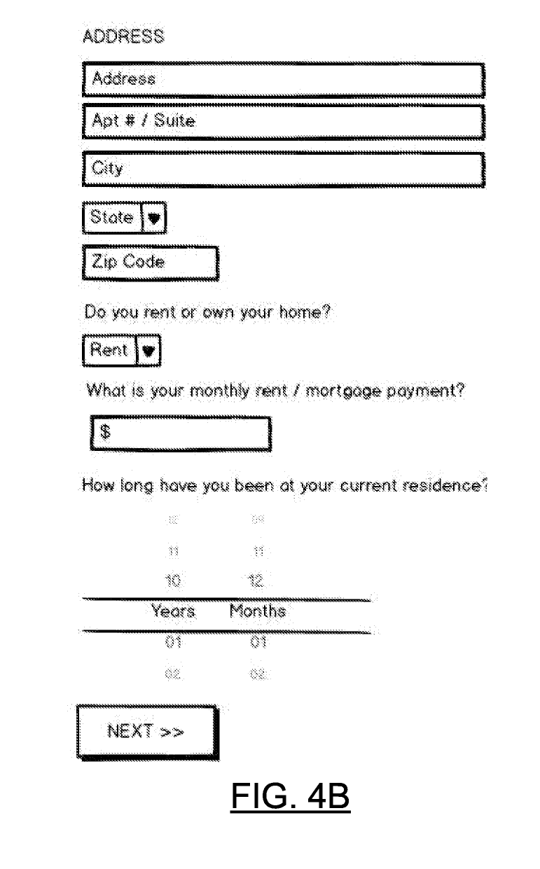

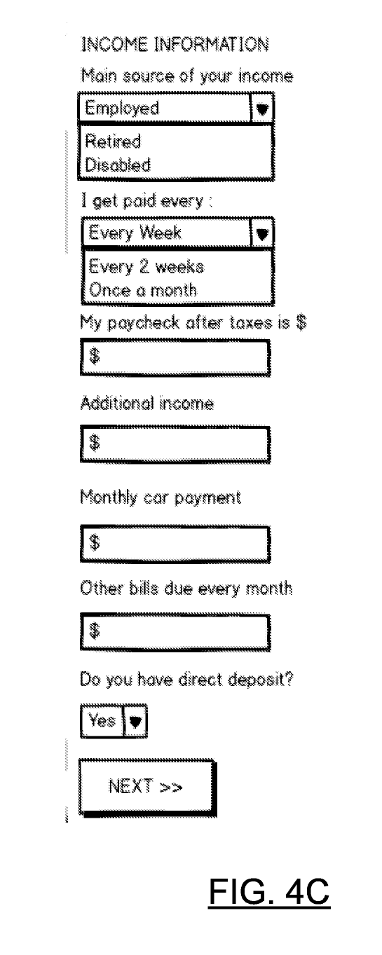

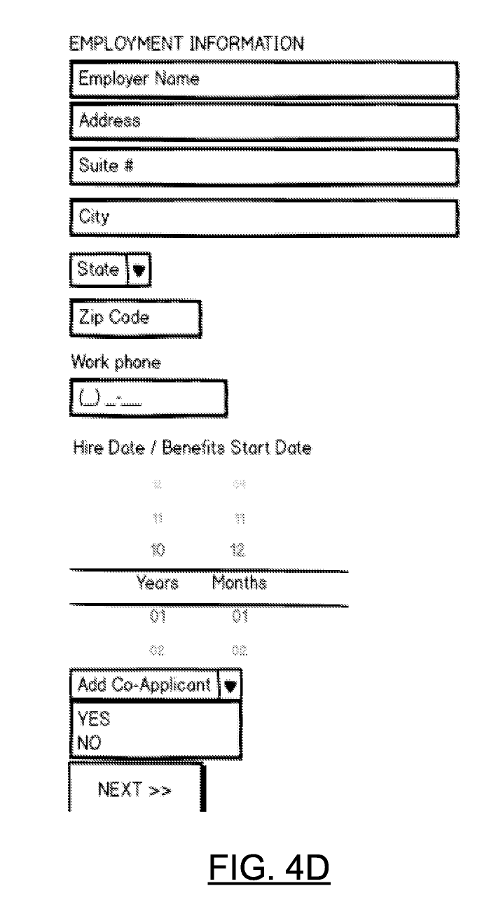

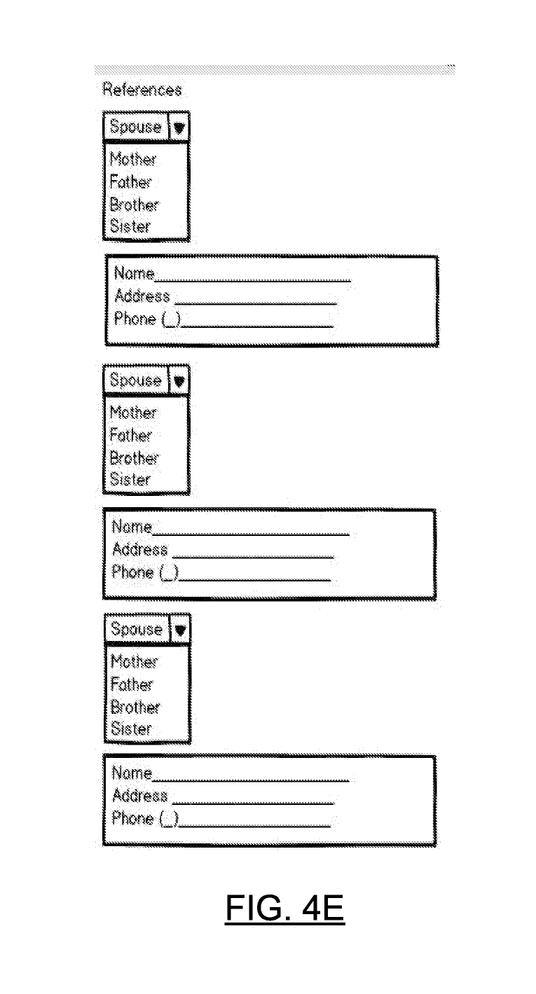

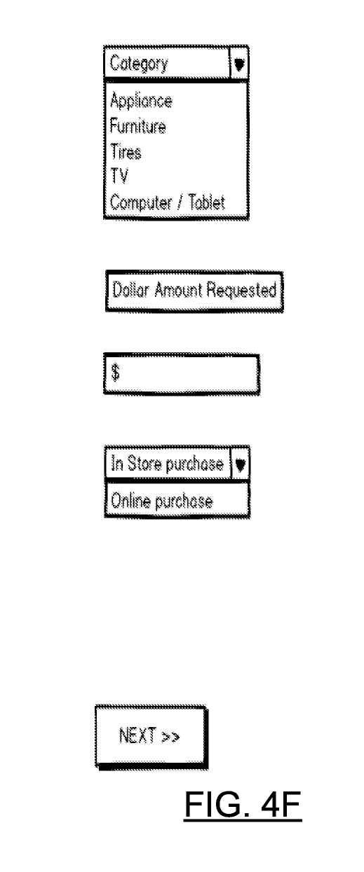

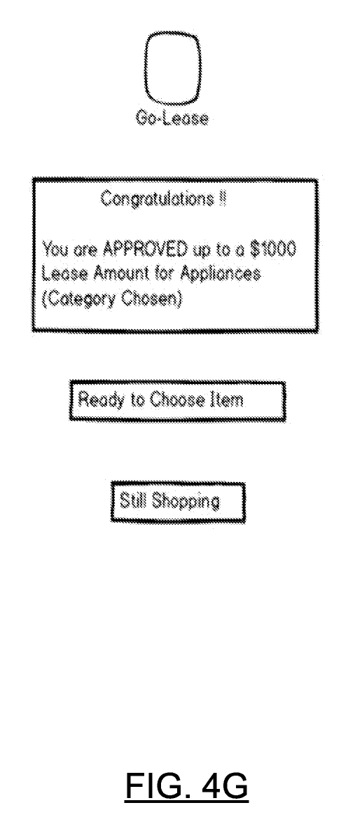

It will be appreciated that any of a variety of customer information that may be used to establish a customer's identity and underwrite a lease may be collected in accordance with various embodiments. For example, in some embodiments, a customer may provide personal information, such as the customer's name (e.g., first name, middle name, and/or last name), the customer's social security number (SSN), the customer's birth date, the customer's contact information (e.g., an email address, mobile phone number, work phone number, home phone number, and/or the like), and/or other personal information identifying the customer. FIG. 4A illustrates a non-limiting example of a graphical user interface that may be displayed on a user device 104 and used by a customer to provide personal information for a lease application in accordance with some example embodiments.

The customer may additionally provide residence information when completing a lease application. For example, a customer may provide his or her address information, including, for example, a street address, apartment/suite number (if applicable), city, state, and zip code. The customer may also indicate whether the customer owns or rents his or her place of residence, and may provide the amount of any rent or mortgage payment (e.g., the monthly amount of any such payment). The customer may additionally indicate a length of time for which the customer has resided at his or her current residence. If the customer has resided at his or her current place of residence for less than a defined duration (e.g., one year), the customer may be prompted to provide information for his or her previous place of residence. FIG. 4B illustrates a non-limiting example of a graphical user interface that may be displayed on a user device 104 and used by a customer to provide residence information for a lease application in accordance with some example embodiments.

The customer may further provide income and liabilities information. For example, the customer may indicate whether the customer is employed, retired, disabled. The customer may additionally specify the customer's pay period (e.g., weekly, twice a month, once a month, etc.) and the amount of the user's paycheck (e.g., gross pay, take home pay after taxes, and/or the like). In some example embodiments, the customer may indicate whether he or she is paid via direct deposit. The customer may further specify any additional sources of income, such as government benefits (e.g., veteran's benefits, disability benefits, welfare benefits, and/or the like). The customer may additionally specify monthly liabilities beyond rent/mortgage payments, such as any monthly car payment(s), other monthly debt payments, monthly utility payments, and/or the like. FIG. 4C illustrates a non-limiting example of a graphical user interface that may be displayed on a user device 104 and used by a customer to provide income and liabilities information for a lease application in accordance with some example embodiments.

In some example embodiments, the customer may capture a digital image(s) of his or her paycheck stub, one or more periodic bills/liabilities, and/or the like (e.g., via use of the camera 322) and include the digital image(s) in the lease application. For example, the lease application module 320 may be configured to cause display of a prompt for the customer to capture and submit a digital image of various evidentiary items to support the customer's claimed income and/or liabilities during the application process.

The customer may further specify employment information, if employed. The employment information may include a name and address of the employer, a work phone number for the customer and/or a number of someone that can verify the customer's employment details. In some example embodiments, the customer may specify an employment start date and/or a start date of any government benefits. In some example embodiments, if the customer has been employed by his or her current employer less than a defined duration (e.g., one year), the customer may be prompted to provide information for his or her previous employer (if any). FIG. 4D illustrates a non-limiting example of a graphical user interface that may be displayed on a user device 104 and used by a customer to provide employment information for a lease application in accordance with some example embodiments.

A customer may also add one or more co-applicant, such as a spouse, parent, or the like to the lease application. The customer may provide information, such as personal information, residence information, income and liabilities information, employment information, and/or the like, for each co-applicant (e.g., via the example graphical user interfaces illustrated in FIGS. 4A-4D).

In some example embodiments, a customer may also provide his or her marital status, an indication of a number of dependents residing with the customer, and information on any additional household income (e.g., income earned by a spouse). In some example embodiments, the customer may capture a digital image of a government issued form of identification, such as a driver license, passport, or the like, (e.g., via use of the camera 322) and include the digital image in the lease application. For example, the lease application module 320 may be configured to cause display of a prompt for the customer to capture and submit the digital image of his or her identification.

In some example embodiments, the customer may additionally provide a digital image of the customer (e.g., a photograph that may include the customer's face). In such embodiments, the digital image of the customer may be captured when completing the application and/or may be a previously captured image that may be accessed and submitted by the customer when completing the application.

The customer may additionally provide one or more references in the lease application. For each reference, the customer may indicate a relationship to the customer, such as a familial relationship (e.g., parent, sibling, etc.), an employment relationship (e.g., boss, coworker, etc.), and/or other indication of the relationship between the reference and the customer. The customer may also provide contact information for a reference, such as a phone number, mailing address, email address, and/or the like. FIG. 4E illustrates a non-limiting example of a graphical user interface that may be displayed on a user device 104 and used by a customer to provide references for a lease application in accordance with some example embodiments.

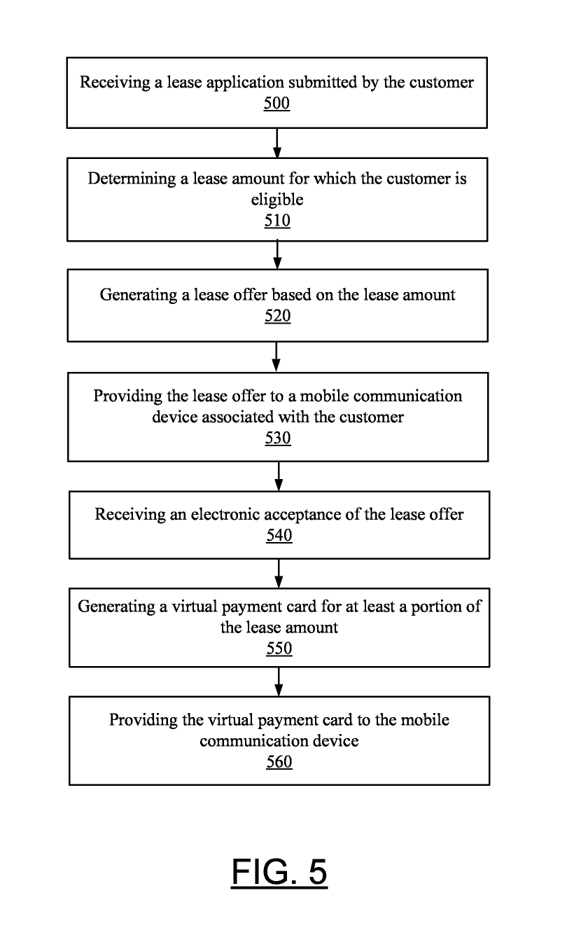

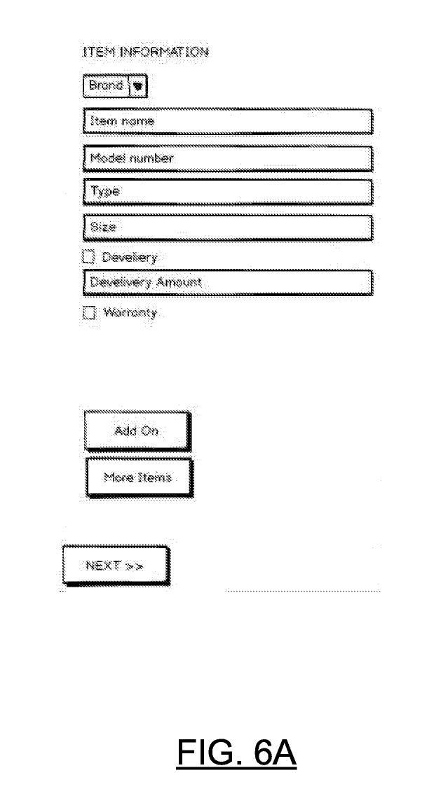

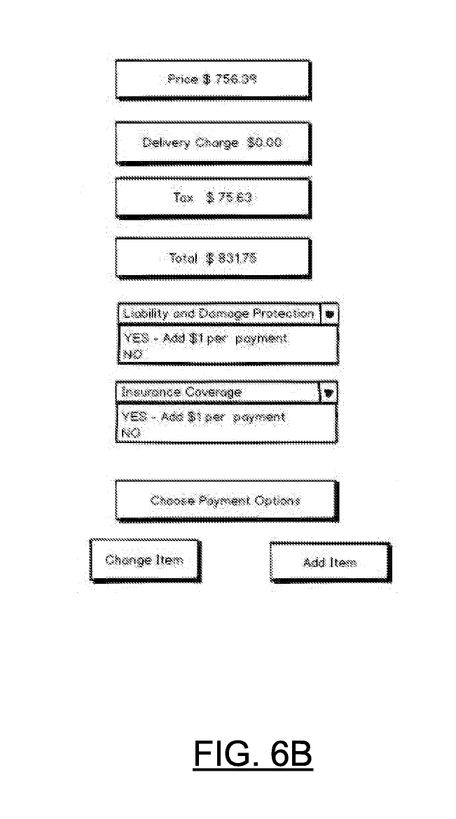

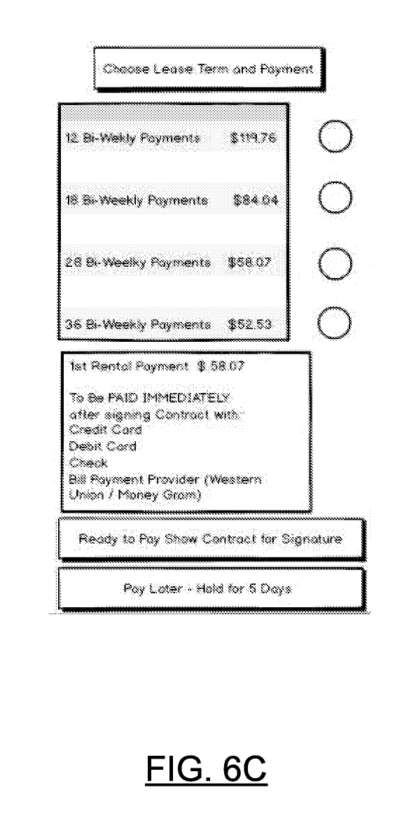

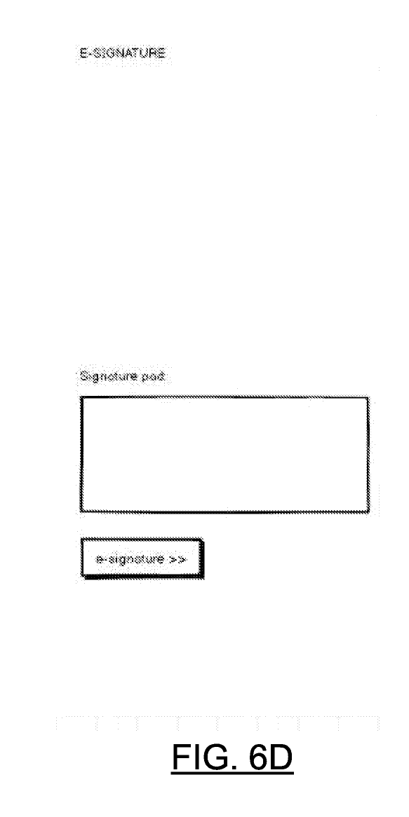

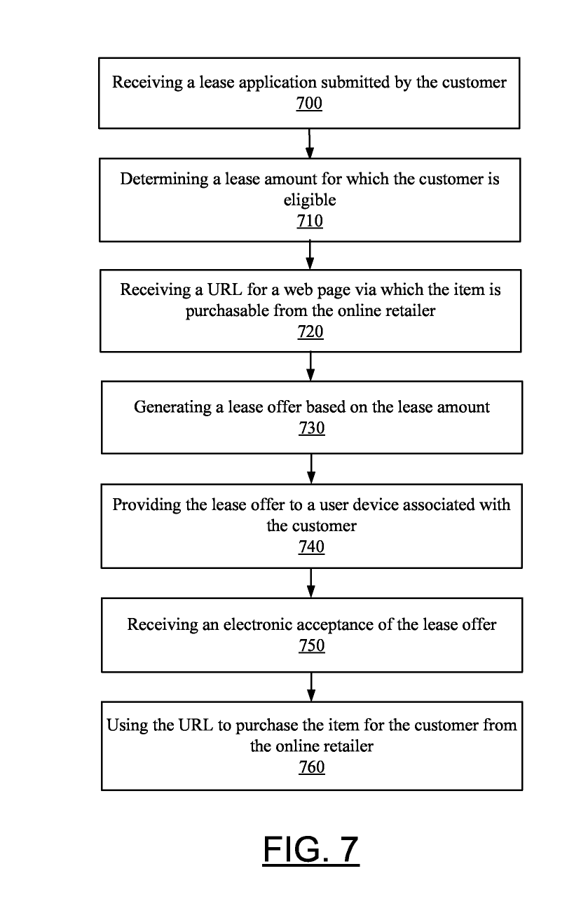

The customer may further provide an indication of the item to be purchased. In some example embodiments, the customer may identify the specific item and/or purchase price. Additionally or alternatively, in some example embodiments, the customer may initially identify a category of the item (e.g., appliance, furniture, tires, electronic device, television, computer, tablet, musical instrument, jewelry, and/or other category of item that may be leased on a rent-to-own basis). The customer may additionally indicate a dollar amount (e.g., a lease amount) requested. The customer may additionally indicate whether the customer is seeking to make an in-store purchase (e.g., a purchase made in a brick and mortar store), which may be completed as described further herein below with respect to FIGS. 5 and 6A-6D, or an online purchase, which may be completed as described further herein below with respect to FIG. 7. FIG. 4F illustrates a non-limiting example of a graphical user interface that may be displayed on a user device 104 and used by a customer specify an item category, a requested lease amount, and whether the lease application is for an in-store purchase or an online purchase in accordance with some example embodiments.

The service provider system 102 may receive a lease application completed by the customer. The lease application may contain the customer information described above and an indication of the item to be purchased. The application processing module 218 may be configured to process the lease application and perform lease underwriting based at least in part on the customer information and the indication of the item to be purchased. In this regard, the application processing module 218 may perform a fraud and risk assessment based at least in part on the customer information and the indication of the item to be purchased. Based on the results of the fraud and risk assessment, the application processing module 218 may be configured to categorize the customer into one of a plurality of risk categories, and may determine a lease amount for which the customer is eligible in accordance with the risk category into which the customer is categorized.

For example, in some embodiments, the fraud and risk assessment may include the application processing module 218 verifying the customer's identity by accessing data associated with the customer that may be available from one or more third party data sources 108. For example, the application module 218 may use data from one or more third party data sources 108 to verify residence information, a phone number(s), email address, and/or other information that may be provided by a customer in a lease application. In some example embodiments in which a customer may submit a digital image of the customer, facial analysis and/or other computer-implemented facial recognition/comparison techniques may be used to compare the image to an image of the customer that may be available from a third party data source 108 to verify that the customer is the person that the customer purports to be. If information provided by the customer does not match information pulled form a third party data source 108, the customer may receive a negative risk factor score, as information included in the lease application may be deemed fraudulent. However, if information provided by the customer does match information pulled form a third party data source 108 such that the customer's identity can be verified, the customer may be given a positive risk factor score for identity verification.

As a further example, in some embodiments, the application processing module 218 may access one or more third party data sources 108 that may provide debt history information for the customer, such as information on outstanding debts, collection status, any past collections notices, any history of overdue payments, and/or other debt information for the customer. If the customer has a history of late payments and/or has been taken to collections, the customer may receive a negative risk factor score, as the customer has a history of failing to make payments. However, if the customer has a history of timely debt payments, the customer may receive a positive risk factor score.

The application processing module 218 may assign a cumulative risk factor score to the customer based on the analysis and processing of the lease application. The cumulative risk factor score may represent a cumulative score calculated based on all negative risk factor scores and positive risk factor scores assigned to the customer through the analysis. The cumulative risk factor score may be calculated further based on a difference between the customer's income and liabilities, which may be indicative of the customer's financial ability to make lease payments.

In some example embodiments, the cumulative risk factor score may be further calculated based on a category of the item the customer is seeking to purchase. For example, an item, such as a large household appliance may be considered a lower risk than a portable electronic device. In this regard, the portable electronic device may be more likely to be lost/damaged and/or easier for a customer to pawn than a large household appliance. As such, if lease obligations are not met by a customer, successful repossession of the portable electronic device may be less likely than successful repossession of a large household appliance, thereby increasing the risk of loss to the rent-to-own service provider.

The application processing module 218 may be configured to categorize the customer into one of plurality of categories (e.g., one of a plurality of score ranges) based on cumulative risk factor score. The lease amount for which the customer is eligible (if the customer is deemed eligible for a lease) may be determined in accordance with the category into which the customer is categorized. For example, a higher risk customer may be entitled to a lower lease amount than a lower risk customer.

In some example embodiments, the application processing module 218 may be configured to determine a location of the user device 104 used by the customer to complete the lease application. The location may be used by the application processing module 218 to verify that the lease application is not fraudulent. In this regard, if the location does not correspond to an appropriate location, such as a store location, the customer's home address, and/or the customer's work address, the application processing module 218 may deem the lease application to be fraudulent and may determine to not extend a lease offer to the customer.

For example, if the user device 104 used by the customer is a mobile communication device including a satellite positioning service receiver, such as a Global Positioning System (GPS) receiver and/or receiver for another satellite positioning service, the user device 104 may provide a location stamp ascertained by the satellite positioning service receiver to the service provider system 102. In some example embodiments in which the lease application may be completed inside a store for an in-store purchase, the application processing module 218 may verify that the location stamp corresponds to a location of the store. As a further example, the application processing module 218 may verify that the location stamp corresponds to a street address of the customer's residence or workplace. In some example embodiments, the application processing module 218 may be configured to resolve the location stamp to a street address and/or store name by looking up the location specified by the location stamp in a geolocation database that may geocode position coordinates to street addresses, store names, and/or the like.

As another example, the application processing module 218 may determine a location of the user device 104 by determining a network address, such as an Internet Protocol (IP) address and/or the like, of the user device 104. The application processing module 218 may resolve the network address to a real world physical location by using a network address lookup service. The application processing module 218 may verify that the location associated with the network address corresponds to one or more of a store address in which the item is to be purchased (e.g., if the customer has applied for a lease for an in-store purchase), a home address of the customer, or a work address of the customer. In instances in which the network address may not be correlated to a street address such that the location associated with the network address is determinable at a courser level of granularity than an actual street address (e.g., if the network address is resolvable to a town, city, zip code, geographic region, or other location area), the application processing module 218 may verify that one or more of a store address, home address, or a work address is located within the location area associated with the network address.

Provided that the application processing module 218 deems the customer eligible for a lease offer after completing the underwriting process, the application processing module 218 may provide one or more of a lease offer or a pre-approval for the lease amount for which the customer is eligible to the user device 104 associated with the user. For example, in some embodiments, the customer may be informed of a pre-approval amount and may then select the actual item to be purchased in order to complete the rent-to-own lease transaction. The pre-approval may be good for some period of time, such as a defined number of days before expiring if the customer does not complete the rent-to-own lease transaction by purchasing an item. FIG. 4G illustrates a non-limiting example of a graphical user interface that may be displayed on a user device 104 to inform a customer of a maximum lease amount for which the customer has been pre-approved prior to selecting the actual item to be purchased in accordance with some example embodiments.

Having now described the lease application and underwriting process in accordance with various example embodiments, techniques for electronically processing a rent-to-own lease transaction for an in-store purchase (e.g., a purchase inside a brick and mortar store) will now be described with respect to FIGS. 5 and 6A-6D. At least a portion of a rent-to-own lease transaction for an in-store purchase may be transacted by a customer on a mobile communication device, such as a smart phone owned by the customer and/or a mobile communication device that may be provided for customer use by the store.

Referring to FIG. 5, FIG. 5 illustrates flowchart according to an example method for electronically processing a rent-to-own lease transaction for an in-store purchase in accordance with some example embodiments. In this regard, FIG. 5 illustrates operations that may be performed by the service provider system 102 (e.g., without human intervention) in accordance with some example embodiments.

Operation 500 may include the service provider system 102 receiving a lease application submitted by a customer. The lease application may be sent to and/or otherwise provided (e.g., over the network 106) to the service provider system 102 by a user device 104. The lease application may include customer information and an indication of the item to be purchased in a brick and mortar store, such as described above.

Operation 510 may include the application processing module 218 determining a lease amount for which the customer is eligible. The determination of operation 510 may be made based at least in part on the customer information and the indication of the item to be purchased through an underwriting process, such as described above.

Operation 520 may include the application processing module 218 generating a lease offer based at least in part on the determined lease amount. Operation 530 may include the service provider system 102 providing the lease offer to a mobile communication device associated with the customer (e.g., an embodiment of a user device 104).

In some example embodiments, the lease application process may be completed in multiple phases such that a customer may be pre-approved for a lease amount (e.g., as illustrated in FIG. 4G) based on a completed portion of a lease application including customer information and a category of the item to be purchased. The lease offer that may be generated in operation 520 after the user has selected the actual item for purchase may accordingly be for an amount up to, but not exceeding the pre-approved lease amount.

When the customer selects the actual item for purchase in store, the customer may provide brand information, model name information, model number information, item size information, item price information, item delivery costs (if any), item installation costs (if any), item warranty costs (if any), applicable tax, and/or other information so that the specific item and purchase costs may be determined by the service provider system 102 and the lease offer terms may be generated. In some example embodiments, item selection may be performed via entry of item information in a graphical user interface, such as that illustrated in FIG. 6A. Additionally or alternatively, in some example embodiments, a user device 104 (e.g., via a camera 322 that may be implemented thereon) may be configured to scan and/or otherwise capture an image of a universal product code (UPC) and/or other barcode carrying item information that may be provided to the service provider system 102 and used by the application processing module 218 to identify the item and/or cost thereof.

The application processing module 218 may then calculate the total cost of the item, including, for example, any applicable tax, delivery costs, installation costs, warranty costs, and/or other costs that may be added onto the sale price. In some example embodiments, customer may also be presented with the option to opt into additional services that may be available from the rent-to-own service provider, such as liability and damage protection, insurance coverage, and/or other services that may be added on for an additional fee that may be included in the lease offer. For example, FIG. 6B illustrates an example graphical user interface that may be displayed to the customer on a user device 104 to confirm the price of an item and enable a user to opt into liability and damage protection and/or insurance coverage services.

After the customer has provided all requisite information to enable the application processing module 218 to ascertain the identity and cost of the item and has selected whether to opt into any additional services that may be offered, the application processing module 218 may provide one or more lease term options, which may be displayed on the user device 104 by the lease application module 320. The provided lease term options may differ in terms of the length of the lease term (e.g., repayment period), the frequency of lease payments (e.g., biweekly, monthly, or other period), and/or the amount of each lease payment. An example graphical user interface that may be displayed to the customer on a user device 104 for selection of a lease term and payment option is illustrated in FIG. 6C. The customer may select a lease term and payment option, and the final lease offer that may be generated in operation 520 may be generated by the application processing module 218 in accordance with the lease term and payment option selected by the customer.

The lease offer that may be provided in operation 530 may be emailed to the customer and/or may be provided to the mobile communication device so that it may be displayed on the mobile communication device for review by the customer. Provided that the customer agrees to the lease terms in the lease offer, the customer may indicate his or her acceptance of the lease offer via the mobile communication device. For example, the lease application module 320 may be configured to cause display of a user interface element enabling the customer to indicate his or her acceptance. In some embodiments in which the mobile communication device includes a touch screen display, the user interface element may comprise a signature block enabling the customer to use a finger or stylus to trace his or her signature on the display. An example of such a signature block is illustrated in FIG. 6D. After inputting his or her signature, the customer may choose to submit the signature to indicate acceptance of the lease offer. As a further example, the graphical user interface may include an electronic signature button that the customer may actuate to trigger generation and submission of an electronic signature indicative of the customer's acceptance of the lease terms. Additionally or alternatively, in some example embodiments, the customer may indicate his or her acceptance by entering a pin code or other secret that may be pre-shared between the customer and the rent-to-own service provider for authorization purposes. It will be appreciated, however, that other modes that may be used to electronically indicate acceptance of an offer such that a lease agreement may be established are contemplated within the scope of the disclosure.

Operation 540 may include the service provider system 102 receiving the electronic acceptance of the lease offer from the mobile communication device. For example, in embodiments in which the customer indicates his or her acceptance by tracing his or her signature on a touch screen display, operation 540 may include receiving a digital image of the signature. As another example, in embodiments in which the customer may enter a pin code or other secret to indicate his or her acceptance, operation 540 may include receiving the secret entered by the customer. The application processing module 218 of some example embodiments may be configured to verify authenticity of the electronic acceptance.

Operation 550 may include the application processing module 218 generating a virtual payment card for at least a portion of the lease amount in response to the customer's acceptance of the lease offer. The virtual payment card may be usable for purchase of the item in the store. For example, the virtual payment card may be a virtual credit card, a virtual pre-paid card, a gift card for the store, or other form of digital payment.

Operation 560 may include the service provider system 102 providing the virtual payment card to the mobile communication device to enable the customer to pay for the item at the store. In this regard, the virtual payment card may be displayable on the display of the mobile communication device such that the displayed virtual payment card may be presentable at a point of sale to pay for the item. For example, in some embodiments, the virtual payment card may include an account code for a payment account that may be enterable at the point of sale for at least partial payment of the item. The virtual payment card may further include a security code, such as a card security code (CSC), card verification data (CVD), card verification number (CVN), card verification value (CVV or CVV2), card verification value code (CVVC), card verification code (CVC or CVC2), verification code (V-code), card code verification (CCV), signature panel code (SPC), or the like, that may be associated with the account number and used for payment authorization. As another example, the virtual payment card of some example embodiments may additionally or alternatively include a digital barcode carrying payment information (e.g., an account number, security code, some combination thereof, or the like). The digital barcode may be scanned by a scanning device at the point of sale to provide at least partial payment for the item.

In some example embodiments, the virtual payment card may be configured to expire if not used within a defined period of time. Application of such an expiration period may reduce the risk of fraudulent transactions. In some such example embodiments, the account number of the virtual payment card may be canceled if the virtual payment card is not used within the defined period of time, such that if the customer presents the virtual payment card at the point of sale, the account will be indicated as canceled. Additionally or alternatively, in some such example embodiments, the virtual payment card may be deleted from the mobile computing device if not used within the defined period of time. As a further example, in some embodiments, the customer may be temporarily added as an authorized signer to an account held by the rent-to-own service provider. The customer may be removed as an authorized signer after presenting the virtual payment card for payment and/or after expiration of the defined period of time.

In some example embodiments, the customer may be required to make a first lease payment at the time of purchase. In some such embodiments, the service provider system 102 may provide a notice of the required first lease payment to the mobile communication device, which may display the notice to the customer along with payment instructions. The first lease payment may be payable to the store such that the item may be purchased in a split transaction, with a first portion of payment to the store being funded by the customer's first lease payment and the remainder being funded by the value of the virtual payment card. In this regard, the virtual payment card may have a value equal to a difference between a purchase price of the item (e.g., including any applicable tax, delivery fees, installation fees, warranty charges, and/or the like) and the first lease payment. Subsequent lease payments may be made to the rent-to-own service provider and/or a designee thereof (e.g., in accordance with terms of the lease agreement).

In some example embodiments, the location of the mobile communication device used by the customer may be verified to be in the store to reduce the risk of fraud. In this regard, the mobile communication device may provide location information, such as a position determined via a satellite positioning system sensor, to the service provider system 102, and the lease processing module 318 may be configured to verify based on the location information that the customer is located on the store. In some such example embodiments, the virtual payment card may only be provided to the mobile communication device in operation 560 if the mobile communication device is verified to be located in the store.

In some example embodiments, the lease application module 320 may be configured to prompt the customer to submit a digital image (e.g., a photograph) of the receipt after purchase. For example, a digital image of the receipt may be captured via the camera 322 and sent to the service provider system 102, where the receipt may be maintained in association with the customer's account and/or with the lease agreement. In some example embodiments, the customer may be prompted to submit the digital image of the receipt before leaving the store, and a location stamp may be submitted with the photo to enable the lease processing module 318 to verify the purchase location. Additionally or alternatively, in some example embodiments, the lease application module 320 and/or the store may send an electronic receipt (e.g., an “e-receipt”) to the service provider system 102

The application processing module 216 may be configured to use a received digital image of a receipt and/or an electronic receipt to perform additional fraud prevention verification by verifying, that the item subject to the rent-to-own transaction was actually purchased. A copy of the digital image and/or electronic receipt may be maintained by the service provider system 102 (e.g., in memory 214).

FIG. 7 illustrates a flowchart according to an example method for electronically processing a rent-to-own lease transaction for an online purchase (e.g., from a retailer website) in accordance with some example embodiments. In this regard, FIG. 7 illustrates operations that may be performed by the service provider system 102 (e.g., without human intervention) in accordance with some example embodiments.

Operation 700 may include the service provider system 102 receiving a lease application submitted by a customer. The lease application may be sent to and/or otherwise provided (e.g., over the network 106) to the service provider system 102 by a user device 104. The lease application may include customer information and an indication of the item to be purchased, such as described above.

Operation 710 may include the application processing module 218 determining a lease amount for which the customer is eligible. The determination of operation 710 may be made based at least in part on the customer information and the indication of the item to be purchased through an underwriting process, such as described above.

In accordance with some example embodiments, a customer may be prompted to enter a uniform resource locator (URL) for a web page via which the item may be purchased from the online retailer. In this regard, the lease application module 320 may be configured to prompt the customer to enter the URL. For example, the customer may copy the URL (e.g., form the web browser) and paste the URL into a graphical user interface used to complete the lease application. Operation 720 may include the service provider system 102 receiving the URL. In some example embodiments, the URL may be received with the lease application that may be received in operation 700, such that the URL may provide the indication of the item based upon which the determination of the lease amount for which the customer is eligible may be made. Additionally or alternatively, in some example embodiments, the URL may be specified by the customer after submitting an initial portion of the lease application based upon which the lease amount for which the customer is eligible may be determined.

Operation 730 may include the application processing module 218 generating a lease offer based at least in part on the determined lease amount. Operation 740 may include the service provider system 102 providing the lease offer to the user device 104 associated with the customer.

In some example embodiments, the lease application process may be completed in multiple phases such that a customer may be pre-approved for a lease amount (e.g., as illustrated in FIG. 4G) based on a completed portion of a lease application including customer information and a category of the item to be purchased. The lease offer that may be generated in operation 730 after the user has selected the actual item for purchase may accordingly be for an amount up to, but not exceeding the pre-approved lease amount.

When the customer selects the actual item for an online purchase, the customer may provide brand information, model name information, model number information, item size information, item price information, item delivery costs (if any), item installation costs (if any), item warranty costs (if any), applicable tax, and/or other information so that the specific item and purchase costs may be determined by the service provider system 102 and the lease offer terms may be generated. In some example embodiments, item selection may be performed via entry of item information in a graphical user interface, which may be similar to that illustrated in FIG. 6A for use with an in-store purchase. Additionally or alternatively, the customer may provide the URL that may be received in operation 720 to identify the actual item for online purchase. In some such embodiments, the URL may be provided in addition to information, such as the brand information, model name information, model number information, etc. Alternatively, in some such embodiments, the URL may be the sole indication of the actual item for online purchase, and the application processing module 218 may be configured to use the URL to determine specific details of the item. For example, the application processing module 218 may be configured to execute a bot that may crawl and/or otherwise analyze the web page specified by the URL for item details to enable the generation of lease terms.

The application processing module 218 may then calculate the total cost of the item, including, for example, any applicable tax, delivery costs, installation costs, warranty costs, and/or other costs that may be added onto the sale price. In some example embodiments, the customer may also be presented with the option to opt into additional services that may be available from the rent-to-own service provider, such as liability and damage protection, insurance coverage, and/or other services that may be added on for an additional fee that may be included in the lease offer. For example, FIG. 6B illustrates an example graphical user interface that may be displayed to the customer on a user device 104 to confirm the price of an item and enable a user to opt into liability and damage protection and/or insurance coverage services.

After the customer has provided all requisite information to enable the application processing module 218 to ascertain the identity and cost of the item and has selected whether to opt into any additional services that may be offered, the application processing module 218 may provide one or more lease term options, which may be displayed on the user device 104 by the lease application module 320. The provided lease term options may differ in terms of the length of the lease term (e.g., repayment period), the frequency of lease payments (e.g., biweekly, monthly, or other period), and/or the amount of each lease payment. The customer may select a lease term and payment option, and the final lease offer that may be generated in operation 730 may be generated by the application processing module 218 in accordance with the lease term and payment option selected by the customer.

The lease offer that may be provided in operation 740 may be emailed to the customer and/or may be provided to the user device 104 associated with the customer so that it may be displayed on the user device 104 for review by the customer. Provided that the customer agrees to the lease terms in the lease offer, the customer may indicate his or her acceptance of the lease offer via the user device 104. For example, the lease application module 320 may be configured to cause display of a user interface element enabling the customer to indicate his or her acceptance. In some embodiments in which the mobile communication device includes a touch screen display, the user interface element may comprise a signature block enabling the customer to use a finger or stylus to trace his or her signature on the display. After inputting his or her signature, the customer may choose to submit the signature to indicate acceptance of the lease offer. As a further example, the graphical user interface may include an electronic signature button that the customer may actuate to trigger generation and submission of an electronic signature indicative of the customer's acceptance of the lease terms. Additionally or alternatively, in some example embodiments, the customer may indicate his or her acceptance by entering a pin code or other secret that may be pre-shared between the customer and the rent-to-own service provider for authorization purposes. It will be appreciated, however, that other modes that may be used to electronically indicate acceptance of an offer such that a lease agreement may be established are contemplated within the scope of the disclosure.

Operation 750 may include the service provider system 102 receiving the electronic acceptance of the lease offer from the user device 104. For example, in embodiments in which the customer indicates his or her acceptance by tracing his or her signature on a touch screen display, operation 750 may include receiving a digital image of the signature. As another example, in embodiments in which the customer may enter a pin code or other secret to indicate his or her acceptance, operation 750 may include receiving the secret entered by the customer. The application processing module 218 of some example embodiments may be configured to verify authenticity of the electronic acceptance.

Operation 760 may include the application processing module 218 using the URL to purchase the item for the customer from the online retailer. For example, in some embodiments, the application processing module 218 may be configured to execute a bot that may access the web page via the URL and purchase the item via the web page. The application processing module 218 may be configured to instruct the online retailer to ship the item to an address (e.g., a home address or work address) provided by the customer in the lease application.

In some example embodiments, the customer may be provided with a bill for a first lease payment when completing the lease agreement. The first lease payment may be payable to the rent-to-own service provider. For example, a customer may provide a credit card number, debit card number, checking account number, and/or the like so that the first lease payment may be processed electronically by the service provider system 102. As a further example, in some embodiments, a customer may have the option of using a bill payment service provider, such as WESTERN UNION™, to facilitate an online cash payment for the first lease payment. In some example embodiments, the application processing module 218 may be configured to wait for receipt of the first lease payment prior to completing purchase of the item in operation 760. Subsequent lease payments may be made to the rent-to-own service provider and/or a designee thereof (e.g., in accordance with terms of the lease agreement).

In some example embodiments, the application processing module 218 may be configured to verify that the customer is in a location corresponding to one or more of the customer's home address or work address before completing a rent-to-own lease transaction for an online purchase. For example, in some embodiments, the application processing module 218 may be configured to determine a network address (e.g., an IP address) associated with the user device 104 being used by the customer and determine a location associated with the network address. The application processing module 218 may verify that the location associated with the network address corresponds to one or more of the customer's home address or work address. If the location associated with the network address does not correspond to one or more of the customer's home address or work address, the application processing module 218 may determine that the transaction is fraudulent, and may determine not to generate/provide the lease offer (e.g., operations 730-740) and/or may determine to terminate processing of the transaction prior to purchasing the item (e.g., operation 760).

In some example embodiments, the rent-to-own service provider may partner with retailer websites to include a rent-to-own payment option for items listed for sale on a website. In such example embodiments, a customer may select the rent-to-own payment option to purchase an item from the website. Underwriting and processing of the customer's lease application to complete the rent-to-own lease transaction may be performed by the service provider system 102 in accordance with various embodiments disclosed herein.

It will be understood that each block of the flowcharts in FIGS. 5 and 7, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which may embody the procedures described herein may be stored by one or more memory devices of a computing device, such as service provider system 102 and/or user device 104, and executed by a processor (e.g., processor 212 and/or processor 312) in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s). Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

Moreover, it will be appreciated that the ordering of blocks and corresponding method operations within the flowchart is provided by way of non-limiting example in order to describe operations that may be performed in accordance some example embodiments. In this regard, it will be appreciated that the ordering of blocks and corresponding method operations illustrated in the flowchart is non-limiting, such that the ordering of two or more block illustrated in and described with respect to the flowchart may be changed and/or method operations associated with two or more blocks may be at least partially performed in parallel in accordance with some example embodiments. Further, in some embodiments, one or more blocks and corresponding method operations illustrated in and described with respect to the flowchart may be optional, and may be omitted.

Functions in accordance with the above described embodiments may be carried out in many ways. In this regard, any suitable means for carrying out each of the functions described above may be employed to carry out various embodiments. In some embodiments, a suitably configured processor (e.g., processor 212 and/or processor 312) may provide all or a portion of the elements. In other embodiments, all or a portion of the elements may be configured by and operate under control of a computer program product. The computer program product for performing the methods of various embodiments of includes at least one computer readable storage medium having computer readable program code stored thereon. The computer readable medium (or media) may, for example, be embodied as and/or otherwise include the memory 214 and/or memory 314. However, it will be appreciated that a computer program product in accordance with various example embodiments may include any data storage device (e.g., a non-transitory computer readable storage medium) that can store data, which can be thereafter read by a computer system. Examples of the computer readable storage media include hard drives, network attached storage (NAS), read-only memory, random-access memory, one or more digital versatile disc (DVDs), one or more compact disc read only memories (CD-ROMs), one or more compact disc-recordable discs (CD-Rs), one or more compact disc-rewritable discs (CD-RWs), one or more Blu-Ray discs, magnetic tapes, flash memory, some combination thereof, and/or other optical and non-optical data storage devices. Some example embodiments may additionally or alternatively use computer readable storage media distributed over a network coupled computer system such that the computer readable code may be stored and executed in a distributed fashion.

It will be appreciated that the various aspects, embodiments, implementations and features of the described embodiments may be used separately or in any combination. Various aspects of the described embodiments may be implemented via computer program product, which may be provided via a computer-readable medium, such as memory 214 and/or memory 314, storing software and/or firmware, hardware, or a combination of hardware and software.

Many modifications and other embodiments of the inventions set forth herein will come to mind to one skilled in the art to which these disclosed embodiments pertain having the benefit of the teachings presented in the foregoing descriptions and the associated drawings. Therefore, it is to be understood that embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure. In this regard, for example, different combinations of elements and/or functions than those explicitly described above are also contemplated within the scope of the disclosure. Although specific terms are employed herein, they are used in a generic and descriptive sense only and not for purposes of limitation.

It should be understood that although the terms first, second, etc. may be used herein to describe various steps or calculations, these steps or calculations should not be limited by these terms. These terms are only used to distinguish one operation or calculation from another. For example, a first calculation may be termed a second calculation, and, similarly, a second step may be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

What is claimed is:

1. A computer-implemented method for electronically processing a rent-to-own lease transaction for an in-store purchase, the method comprising:
receiving a lease application submitted by a customer for the rent-to-own lease transaction, the lease application comprising customer information and an indication of an item to be purchased in a brick and mortar store;
determining, based at least in part on the customer information and the indication of the item, a lease amount for which the customer is eligible;
generating a lease offer based on the lease amount;
providing the lease offer to a mobile communication device associated with the customer;
receiving an electronic acceptance of the lease offer;
receiving location information from the mobile communication device, wherein the location information is indicative of a location of the mobile communication device;
verifying, based at least in part on the location information, that the customer is located in the brick and mortar store;
generating a virtual payment card for at least a portion of the lease amount, wherein the virtual payment card is usable for purchase of the item in the brick and mortar store; and
providing the virtual payment card to the mobile communication device,
wherein the virtual payment card is not provided to the mobile communication device if the customer is not verified to be located in the brick and mortar store, and
wherein receiving the lease application, determining the lease amount, generating the lease offer, providing the lease offer, receiving the electronic acceptance, generating the virtual payment card, and providing the virtual payment card are performed without human intervention.

2. The computer-implemented method of claim 1, further comprising:
informing the customer of a first lease payment amount payable to the brick and mortar store at time of purchase of the item;
wherein the virtual payment card has a value equal to a difference between a purchase price of the item and the first lease payment amount.

3. The computer-implemented method of claim 1, wherein the virtual payment card comprises an account number and an associated security code enterable at a point of sale of the brick and mortar store.

4. The computer-implemented method of claim 1, wherein the virtual payment card comprises a digital barcode carrying payment information, and wherein the digital barcode is configured for display on a display of the mobile communication device.

5. The computer-implemented method of claim 1, wherein the virtual payment card is one of a virtual credit card, a virtual pre-paid card, or a gift card for the brick and mortar store.

6. The computer-implemented method of claim 1, wherein the virtual payment card is configured to expire if not used within a defined period of time.

7. The computer-implemented method of claim 1, wherein determining the lease amount for which the customer is eligible comprises:
categorizing the customer into one of a plurality of risk categories based at least in part on the customer information and a category of the item; and
determining the lease amount based at least in part on the one of the plurality of risk categories into which the customer is categorized.

8. The computer-implemented method of claim 1, further comprising:
accessing data associated with the customer from a third party data source over a computer network,
wherein the lease amount is determined further based on the data associated with the customer.

9. A computer-implemented method for electronically processing a rent-to-own lease transaction for an in-store purchase, the method comprising:
receiving a lease application submitted by a customer for the rent-to-own lease transaction, the lease application comprising customer information and an indication of an item to be purchased in a brick and mortar store;
determining, based at least in part on the customer information and the indication of the item, a lease amount for which the customer is eligible;
generating a lease offer based on the lease amount;
providing the lease offer to a mobile communication device associated with the customer;
receiving an electronic acceptance of the lease offer;
generating a virtual payment card for at least a portion of the lease amount, wherein the virtual payment card is usable for purchase of the item in the brick and mortar store; and
providing the virtual payment card to the mobile communication device,
wherein receiving the lease application, determining the lease amount, generating the lease offer, providing the lease offer, receiving the electronic acceptance, generating the virtual payment card, and providing the virtual payment card are performed without human intervention.

10. The computer-implemented method of claim 9, further comprising:
receiving location information from the mobile communication device, wherein the location information is indicative of a location of the mobile communication device; and
verifying, based at least in part on the location information, that the customer is located in the brick and mortar store,
wherein the virtual payment card is only provided to the mobile communication device when the customer is verified to be located in the brick and mortar store.

11. The computer-implemented method of claim 9, further comprising:
informing the customer of a first lease payment amount payable to the brick and mortar store at time of purchase of the item;
wherein the virtual payment card has a value equal to a difference between a purchase price of the item and the first lease payment amount.

12. The computer-implemented method of claim 9, wherein the virtual payment card comprises one of:
an account number and an associated security code enterable at a point of sale of the brick and mortar store; or
a digital barcode carrying payment information, and wherein the digital barcode is configured for display on a display of the mobile communication device.

13. The computer-implemented method of claim 9, wherein the virtual payment card is one of a virtual credit card, a virtual pre-paid card, or a gift card for the brick and mortar store.

14. The computer-implemented method of claim 9, wherein the virtual payment card is configured to expire if not used within a defined period of time.

15. The computer-implemented method of claim 9, further comprising:
receiving one of a digital image of a receipt for purchase of the item or an electronic receipt for purchase of the item; and
verifying based at least in part on the one of the digital image of the receipt or the electronic receipt that the item was purchased in the brick and mortar store.

16. A computer-implemented method for electronically processing a rent-to-own lease transaction for an online purchase, the method comprising:
receiving a lease application submitted by a customer for the rent-to-own lease transaction, the lease application comprising customer information and an indication of an item to be purchased from an online retailer;
determining, based at least in part on the customer information and the indication of the item, a lease amount for which the customer is eligible;
receiving a uniform resource locator (URL) for a web page via which the item is purchasable from the online retailer;
generating a lease offer based on the lease amount;
providing the lease offer to a computing device associated with the customer;
receiving an electronic acceptance of the lease offer; and
purchasing the item for the customer from the online retailer, using the URL,
wherein receiving the lease application, determining the lease amount, receiving the URL, generating the lease offer, providing the lease offer, receiving the electronic acceptance, and purchasing the item are performed without human intervention.

17. The computer-implemented method of claim 16, further comprising, when purchasing the item from the online retailer:
instructing the online retailer to ship the item to an address provided by the customer in the lease application.

18. The computer-implemented method of claim 16, further comprising:
providing a bill for a first lease payment to the computing device; and
receiving electronic payment for the first lease payment prior to purchasing the item from the online retailer.

19. The computer-implemented method of claim 16, further comprising:
determining a network address of the computing device;
determining a location associated with the network address; and
verifying that the location associated with the network address corresponds to one or more of a home address or a work address of the customer provided in the lease application,
wherein the lease offer is only provided in an instance in which the location associated with the network address is verified to correspond to one or more of the home address or the work address.

20. The computer-implemented method of claim 16, wherein determining the lease amount for which the customer is eligible comprises:
categorizing the customer into one of a plurality of risk categories based at least in part on the customer information and a category of the item; and
determining the lease amount based at least in part on the one of the plurality of risk categories into which the customer is categorized.
